(19) United States
(12) Patent Application Publication
(10) Pub. No.: US 2018/0026386 A1
(43) Pub. Date: Jan. 25, 2018

(54) Coupling for Power Cables

(71) Applicant: TBI Industries GmbH, Fernwald (DE)

(72) Inventor: Oliver BINZEL, Muttenz (CH)

(21) Appl. No.: 15/673,131

(22) Filed: Aug. 9, 2017

Related U.S. Application Data
(63) Continuation of application No. PCT/EP2016/053051, filed on Feb. 12, 2016.

(30) Foreign Application Priority Data
Feb. 13, 2015 (DE) 102015001717.9

(51) Int. Cl. H01R 13/213; H01R 4/30; H01R 13/625

(52) U.S. Cl. CPC H01R 13/213; H01R 13/625; H01R 4/302

(57) ABSTRACT

The invention relates to a coupling for power cables, consisting of a plug part (1) and a socket part, said plug part (1) having a basic body (2) comprising a coupling pin (3) on which a locking pin (4) is arranged, said locking pin (4) being mounted in the plug part (1) so as to be displaceable in the axial direction of the coupling pin (3), said locking pin (4) being held in a basic position towards a back end (11) of the coupling pin (3) by a spring force and, while the coupling is being locked, being moved by interlocking with a helical groove of the socket part towards the front end (12) of the coupling pin (3) and a spring device (16) being loaded in the process.

### CROSS REFERENCE TO RELATED APPLICATIONS

This application is a continuation of International Application No. PCT/EP2016/053051, filed on Feb. 12, 2016, which claims priority under 35 U.S.C. §119 to Application No. DE102015001717.9 filed on Feb. 13, 2015, the entire contents of both of which are hereby incorporated by reference.

### TECHNICAL FIELD

The invention relates to a coupling for power cables according to the preamble of claim 1.

### BACKGROUND

Couplings of the type mentioned above comprise coupling elements which are locked by means of a bayonet connector. Since both coupling elements, i.e. the plug part and the socket part, are solidly made according to the state of the art, a rigid connection is attained which remains in the locked position only due to the friction forces.

In order to maintain a largest possible friction force, a normal force is produced via a bayonet mechanism, said normal force pressing the plug and the socket together. Moreover, a strong normal force is important for maintaining a low-impedance electric transition between the plug part and the socket part.

The design principle described here of the coupling having a plug part and a socket part is generally used in welding installations. Today, DIN EN 60974-12 “Coupling devices for welding cables” exists as a standard for conventional connectors used in welding technology, many components found in the market being realized according to said standard. The components differ from producer to producer due to numerous remaining liberties in design and construction when it comes to the standard's application. An ideal compatibility is not readily ensured.

A problem which commonly occurs in practice is that the plug connections known thus far can detach of their own accord after a period of time. This can be led back to a purely constructive principle as both the plug part and the socket part are comparatively rigid components. After locking the plug connection, only a very slight elastic deformation of the parts is possible so that the contact surfaces are immediately lifted upon the slightest back rotation of the connectors and the normal force between the components drops to zero. In this condition, the electric contact resistance of the contact increases dramatically.

In practice, the described detachment process often arises in particular via mechanical vibrations, via an increase in the temperature of the plug connectors during operation and heat expansions connected thereto or also via a setting behavior of the contact surfaces. Consequently, an even larger and irregular increase in the temperature of the components occurs via the increased contact resistance, which can amplify the effect.

The increase in temperature can further lead to damage to the connectors, their insulation or the connected cables or machine parts.

In welding installations, the increased contact resistance of the connection, which often fluctuates in dependence of vibrations, often causes a temporally variable drop in voltage in the power-cable connection and thus in the electric circuit when there is a loose connection. Through this, the electric arc voltage is involuntarily influenced; the quality of the welding process can drop or become instable.

### SUMMARY

The object of the present invention is to reliably prevent the plug connection of the coupling from detaching of its own accord and to produce a lowest possible, constant contact resistance. The plug parts and the socket parts should be compatible with the commonly known elements so that components made by different producers can be combined without any difficulties.

In order to attain this object, the coupling according to the invention has the features of claim 1.

In the coupling according to the invention, the locking pin is displaceably mounted in the plug part in the axial direction of the coupling pin, said locking pin being held in a basic position towards a back end of the coupling pin by means of a spring device and the locking pin being moved in the socket part towards the front end of the coupling pin via a form fit when the engagement connection is produced between the plug part and the socket part and the spring device thus being loaded so as to form a pre-load force.

By implementing the solution according to the invention, it is attained that an elastic element is inserted into the system so that a sufficiently high normal force can be maintained between the plug part and the socket part in a large displacement area of the bayonet connector. For this purpose, the current transition areas formed in particular by the front sides of the plug part and the socket part are not changed so that they are formed directly on solid components as in the state of the art. The elasticity is implemented via a resiliently mounted locking pin which is realized such that it can be inserted into the guiding groove of the bayonet connector when in the unloaded position and is loaded against spring force while being locked by rotating the plug part and the socket part against each other. A significant decrease in the contact force between the two coupling halves due to small changes in the system, such as a slight loosening, thermal expansion or setting occurrences between the contact surfaces, is reliably prevented by the invention.

In comparison to known solutions, the coupling according to the invention thus is more secure against a self-actuated detachment and is compatible with generic components on the market.

The invention is an advancement of known coupling elements for high-voltage connections, the transferred voltages generally being between approximately 20 and 600 A. The elements are preferably realized unipolar and serve for low-impedance connections of flexible copper cables having cross sections of approximately 10 to 120 mm2. The plug part or the socket part can also be realized as bulkheads for installation in machines or switch cabinets.

In the simplest embodiment, only the plug part can be realized changed in comparison to now commonplace components.

An essential advantage of the coupling according to the invention is that disruptive influences on the welding process due to loosening connections can be eliminated. The improved plug connection between the plug part and the socket part can easily be retrofitted into existing systems and also be combined with other components.

In a preferred embodiment, the coupling pin of the plug part is provided with a central through bore as well as a radial recess, in particular one produced by milling, a tension rod guided in the central through bore being provided with the radially arranged locking pin at its front end, said locking pin passing through the radial recess and the spring device being arranged between the basic body and the tension rod in such a manner that when the engagement connection is produced between the plug part and the socket part, the locking pin is displaced into the socket part and the pre-load force becomes larger.

Alternatively, the coupling pin can be mounted in the basic body of the plug part in an axially displaceable manner, said coupling pin being provided with a radially arranged locking pin and the spring device being arranged between the basic body and the coupling pin in such a manner that when the engagement connection is produced between the plug part and the socket part, the coupling pin is pulled out of the basic body and the spring force becomes larger.

Preferably, the spring device comprises at least one plate spring.

At the front end of the coupling pin, a stop can be formed for limiting the movement of the locking pin.

Preferably, the stop for the movement of the locking pin is defined by the end of the spring path of the at least one plate spring.

If the groove formed in the socket part comprises a groove segment arranged parallel to the front side at the end of the groove facing away from the front side in such a manner that when the engagement connection is produced between the plug part and the socket part, a continuous increase of the pre-load of the spring device remains constant at first while the locking pin is being displaced in the area of the helical segment of the groove and subsequently the pre-load remains constant while the locking pin is being displaced in the area of the groove segment, a noticeable locking connection can be realized in another advantageous embodiment which provides additional protection against an unintended detachment.

In another embodiment, the groove formed in the socket part can comprise a groove segment facing back to the front side at the end of the groove facing away from the front side in such a manner that when the engagement connection is produced between the plug part and the socket part, a continuous increase of the pre-load of the spring device is continuously reduced at first while the locking pin is being displaced in the area of the helical segment and subsequently the pre-load is continuously reduced while the locking pin is being displaced in the area of the groove segment.

It is particularly advantageous if either the plug part or the socket part is intended to be installed in an electrical device.

### BRIEF DESCRIPTION OF THE DRAWINGS

In the following, advantageous embodiments of the invention are further described by way of the drawing.

In the drawing,

FIG. 1 shows a plug part of a coupling in an isometric view;

FIG. 2 shows a longitudinal cut through the plug part shown in FIG. 1;

FIG. 3 shows a top view of the plug part shown in FIG. 1;

FIG. 4 shows a socket part of a coupling in an isometric view;

FIG. 5 shows a side view of the socket part shown in FIG. 4;

FIG. 6 shows a partial cross-sectional view of a basic body of the socket part shown in FIG. 4 according to the cutting line VI-VI in FIG. 4;

FIG. 7 shows a cross-sectional view of the basic body shown in FIG. 6 according to the cutting line VII-VII in FIG. 6 along with a view of a first embodiment of a groove formed in the basic body;

FIG. 8 shows a second embodiment of the groove shown in FIG. 7.

### DETAILED DESCRIPTION

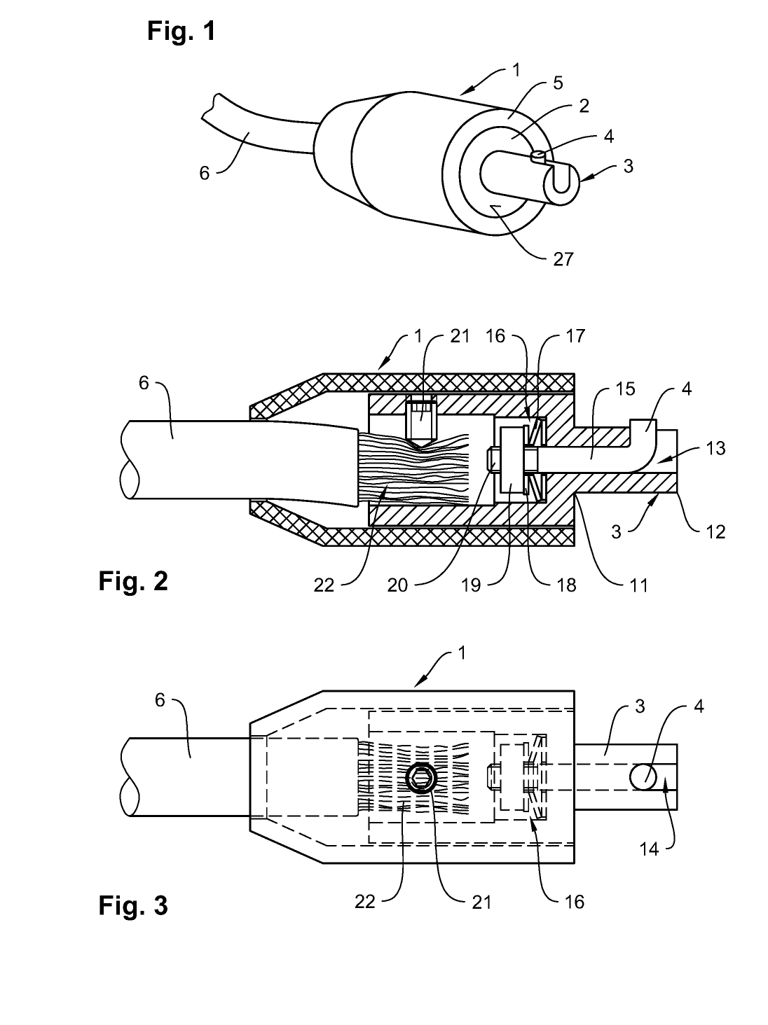

In a synopsis of FIGS. 1 to 3, a plug part 1 of the coupling is shown which comprises a coupling pin 3 which starts from a front side 27 of a basic body 2 and has a longitudinal bore 13. In conjunction with the longitudinal bore 13, the coupling pin 3 comprises a recess 14 preferably produced by milling for accommodating a locking pin 4. The locking pin 4 is formed by an elbowed end of a tension rod 15 accommodated in the longitudinal bore 13, said locking pin 4 formed by the elbowed end passing through the recess 14 and radially protruding over the coupling pin 3. This elbowed and protruding end of the tension rod 15 forms the locking pin 4 which can be displaced in the longitudinal direction of the plug part 1, the other end of the tension rod 15 being locked against the basic body 2 of the plug part 1 by means of a spring device 16 which comprises a plate spring 17 in the present instance. For this purpose, the plate spring 17 is arranged between a bore offset of the longitudinal bore 13 formed in a basic body 2 and a nut 19 arranged on a thread offset 20 of the tension rod 15 in the illustrated exemplary embodiment.

Using one or more plate springs as a spring element of the spring device 16 proves to be particularly advantageous since plate springs are able to develop large spring forces in small ranges and installation spaces. It is also particularly advantageous if the maximum spring path of the locking pin 4 can be limited without any other components by pressing the spring plate flat and the plate spring then forming a mechanically stiff stop. By tightening the coupling accordingly, the same high contact forces can be attained between the two coupling halves as in rigid couplings according to the state of the art which comprise an immovable locking pin.

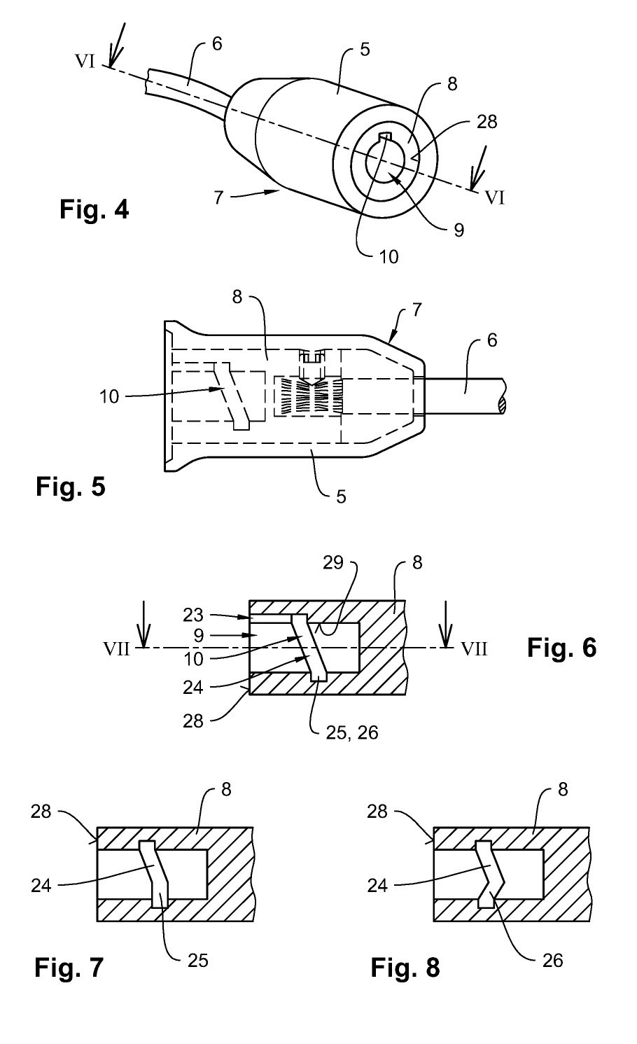

In FIGS. 4 to 8, a socket part 7 is shown which comprises an accommodating bore 9 formed in a basic body 8 for accommodating the coupling pin 3 of the plug part 1. In a bore wall 29 of the basic body 8, a groove 10 is formed which comprises different groove segments, namely a groove beginning segment 23, a helical segment 24 and a groove segment 25 and 26. By combining groove segments with different inclinations, the coupling can be better secured against becoming unintendedly loosened. The groove beginning segment 23 extends to the accommodating bore 9 arranged parallel to the axis starting from a front side 28 of the basic body 8. The groove beginning segment 23 serves to easily insert the coupling pin 3 of the plug part 1 into the socket part 7. The helical segment 24 follows immediately thereafter, said helical segment 24 comprising a constant positive inclination.

In order to produce a coupling connection between the plug part 1 and the socket part 7, the locking pin 4 is inserted into the groove beginning segment 23. When subsequently rotating the plug part 1 against the socket part 7, the locking pin 4 of the plug part 1 follows the helical segment 24 of the groove 10, whereby the coupling parts are pulled together like in a bayonet connector, a surface contact is formed between the front sides 27, 28 and the spring device 16 is loaded.

In the embodiment of the groove 10 shown in FIG. 7, a groove segment 25 connects with zero inclination, i.e. the groove segment 25 extends parallel to the front side 28 of the basic body. Once the locking pin 4 reaches the groove segment 25, the spring device 16 is not loaded any further. However, a force component is no longer produced which is directed towards the opening rotating direction of the coupling, something that is still the case with a positive inclination in the helical segment 24. Only the friction forces between the coupling parts, i.e. the plug part 1 and the socket part 7, act against this force component so that the coupling can be opened more easily, i.e. with less expenditure of force, than it can be closed. It is achieved via the arrangement of the groove segment 25 that internal forces in the coupling are no longer exerted when opening the connection and that the required external force for opening the connection is increased since the supporting force is dispensed via the inclined plane between the locking pin 4 and the helical segment 24.

When guiding the locking pin 4 into the helical segment 24 of the groove 10, i.e. when locking the bayonet connector, subsequent to the plug part 1 shown in FIG. 2 being inserted into the socket part 7 shown in FIG. 5, the tension rod 15 is pulled out of the plug part 1 against the pre-load force of the spring device 16, whereby the contact force is precisely defined. When loosening the plug part 1, the contact force between the front sides 27, 28 forming the contact surfaces continuously drops according to the characteristic curve of the spring, a sudden release and thus an immediate loosening of the connection as in the state of the art being reliably prevented. Thermal expansion and setting behaviors of the connection are elastically compensated without it having to come to a relevant change in the pre-load force. Thus, the ohmic contact resistance of the connection practically remains constant.

This new situation, which represents a significant technological advancement, only becomes possible via the socket part according to the invention. Additionally, the socket part according to the invention can be realized in such a manner that it remains compatible with already existing plug parts realized in a rigid manner having an immovable locking pin according to the state of the art. This is attained by realizing the helical segment so that a rigidly installed locking pin, which is geometrically realized according to the standard IEC 60974-12, cannot reach the subsequent groove segment.

In the embodiment of the groove 10 shown in FIG. 8, the groove segment 26 comprises a negative inclination so that the groove segment 26 is faced back towards the front side 28. In this instance, the user of the coupling will notice a significant change in the tightening torque when the spring-loaded locking pin 4 is transferred from the helical segment 24 having a positive inclination into the groove segment 26 having a negative inclination. This tightening torque will suddenly decrease when the helical segment 24 transfers to the groove segment 26 which will intuitively be understood as the coupling locking. The user will therefore know that the coupling is correctly locked. For detaching the coupling, an increasing torque must first be mustered in order to overcome the transition point between the helical segment 24 and the groove segment 26 of the groove 10. An accidental loosening is therefore not possible.

What is claimed is:

1. A coupling for power cables having a plug part (1) and a socket part (7), said plug part (1) and said socket part (7) comprising a device for connecting a power cable (6) in a fixed manner, said plug part (1) comprising a basic body (2) which has a coupling pin (3) projecting over a front side (27) of the basic body (2) and is arranged in the axial direction of the coupling and has a locking pin (4) laterally arranged on the coupling pin (3), said socket part (7) comprising a basic body (8) which is provided with an axial bore (9) for accommodating the coupling pin (3), said axial bore (9) comprising, in a bore wall (29), a groove (10) which starts from a front side (28) of the basic body (8) and comprises a helical segment (24) and extends to the front end of the basic body (8), said groove (10) serving to accommodate a locking pin (4) of the plug part (1) such that when an engagement connection is produced between the plug part (1) and the socket part (7), the coupling pin (3) is inserted into the bore (9) of the socket part (7) in such a manner that the locking pin (4) is accommodated in the groove (10) of the socket part (7) and the plug part (1) and the socket part (7) are clamped against each other like a bayonet connector by means of the locking pin (4) guided in the groove (10) via a subsequent relative rotation of the plug part (1) and the socket part (7), characterized in that the locking pin (4) is displaceably mounted in the plug part (1) in the axial direction of the coupling pin (3), said locking pin (4) being held in a basic position towards a back end (11) of the coupling pin (3) by means of a spring device (16) and said locking pin (4) being displaced towards the free end (12) of the coupling pin (3) by interlocking with the groove (10) in the socket part (7) when the engagement connection is produced between the plug part (1) and the socket part (7) and the spring device (16) thus being loaded so as to form a pre-load force.

2. The coupling for power cables according to claim 1, characterized in that the coupling pin (3) of the plug part (1) is provided with a central through bore (13) as well as a radial recess (14), a tension rod (15) being guided in the central through bore (13), said tension rod (15) being provided with the locking pin (4) radially arranged on the front end, said locking pin (4) passing through the radial recess (14) and the spring device (16) being arranged between the basic body (2) and the tension rod (15) in such a manner that when the engagement connection is produced between the plug part (1) and the socket part (7), the locking pin (4) is displaced into the socket part (7) and the pre-load force increases.

3. The coupling for power cables according to claim 1, characterized in that the spring device (16) comprises at least one plate spring (17).

4. The coupling for power cables according to claim 1, characterized in that a stop for limiting the movement of the locking pin is formed at the front end of the coupling pin.

5. The coupling for power cables according to claim 4, characterized in that the stop for the movement of the locking pin (4) is defined by the end of the spring path of the at least one plate spring (17).

6. The coupling for power cables according to claim 1, characterized in that the coupling pin is mounted axially displaceable in the basic body of the socket part, said coupling pin being provided with a radially arranged locking pin and the spring device being arranged between the basic body and the coupling pin in such a manner that when the engagement connection is produced between the plug part and the socket part, the coupling pin is pulled out of the basic body and the pre-load force increases.

7. The coupling for power cables according to claim 1, characterized in that the groove (10) formed in the socket part (7) comprises a groove segment (25) arranged parallel to the front side (28) at the end of the groove (10) facing away from the front side (28) in such a manner that when the engagement connection is produced between the plug part (1) and the socket part (7), a continuous increase of the pre-load of the spring device (16) remains constant at first while the locking pin (4) is being displaced in the area of the helical segment (24) of the groove (10) and subsequently the pre-load force remains constant while the locking pin (4) is being displaced in the area of the groove segment (25).

8. The coupling for power cables according to claim 1, characterized in that the groove (10) formed in the socket part (7) comprises a groove segment (26) facing back to the front side (28) at the end of the groove (10) facing away from the front side (28) in such a manner that when the engagement connection is produced between the plug part (1) and the socket part (7), a continuous increase of the pre-load force of the spring device (16) is continuously reduced at first while the locking pin (4) is being displaced in the area of the helical segment (24) of the groove (19) and subsequently the pre-load force is continuously reduced while the locking pin (4) is being displaced in the area of the groove segment (26).

9. The coupling for power cables according to claim 1, characterized in that either the plug part (1) or the socket par (7) is intended to be installed in an electrical device.
